(19) United States
(12) Patent Application Publication
(10) Pub. No.: US 2022/0097845 A1
(43) Pub. Date: Mar. 31, 2022

(54) UNMANNED AERIAL VEHICLE AND INSPECTION METHOD

(71) Applicant: MITSUBISHI POWER, LTD., Yokohama-shi, Kanagawa (JP)

(72) Inventors: Masaki Honda, Tokyo (JP); Masaki Kitamura, Yokohama-shi (JP); Kazuki Eguchi, Tokyo (JP); Ryo Hashimoto, Tokyo (JP)

(73) Assignee: MITSUBISHI POWER, LTD., Yokohama-shi, Kanagawa (JP)

(21) Appl. No.: 17/421,070

(22) PCT Filed: Jan. 31, 2020
(86) PCT No.: PCT/JP2020/003744

§ 371 Date: Jul. 7, 2021

(30) Foreign Application Priority Data
Feb. 27, 2019 (JP) 2019-033439

(51) Int. Cl. B64C 39/02; B64D 47/08

(52) U.S. Cl. CPC B64C 39/024; G01S 17/08; B64D 47/08

(57) ABSTRACT

An unmanned aerial vehicle is an unmanned aerial vehicle configured to fly in a closed space, which includes an airframe, a thrust generating means configured to generate a thrust for the airframe to fly in air, and a length measuring means mounted on the airframe. The length measuring means includes a transmission unit configured to transmit a measurement wave, a reception unit configured to receive reflected waves of the measurement wave, and a distance calculation unit configured to calculate a distance between the unmanned aerial vehicle and a stationary object present in the closed space based on the reflected waves of the measurement wave transmitted from the transmission unit which are received a plurality of times by the reception unit.

### TECHNICAL FIELD

The present disclosure relates to an inspection technique for a closed space and, in particular, relates to an inspection technique using an unmanned aerial vehicle.

### BACKGROUND

For example, a combustion furnace such as a boiler used in a thermal power plant needs to periodically stop an operation after the start of the operation for a worker to enter the inside of the combustion furnace to conduct maintenance inspection. Although a position of an inspection portion (inspection position) in the furnace needs to be clarified in the maintenance inspection, the capacity of the combustion furnace is large, making it difficult to accurately grasp the inspection position visually. Thus, conventionally, there has been a method of grasping the inspection position by measuring a height position and a side position of the inspection portion with a tape measure or the like for marking. However, such method needs building a scaffolding and installing a gondola for the worker, requiring a great effort, cost, and inspection period.

Meanwhile, in inspecting an outdoor structural object, there is also an unmanned inspection technique capable of eliminating the need to building the scaffolding by the use of an unmanned vehicle and GPS (Global Positioning System). However, even if such method is to be applied to inspection of the inside of a structural object such as a boiler or a stack, radio waves from a satellite do not penetrate, making it impossible to grasp a flight position of the unmanned vehicle by GPS and to perform stable control of the unmanned vehicle. Accordingly, it is difficult to apply such inspection technique to inspection inside the structural object.

To cope with the above problem, for example, Patent Document 1 discloses an unmanned floating device (unmanned aerial vehicle) including a floating means such as a propeller, where, for example, a distance measurement unit (such as a laser scanner or a ultrasonic sensor) for measuring a distance between the unmanned floating device and an inner wall surface of a structural object such as a boiler (boiler furnace), and an imaging unit for imaging structures (such as a pipe and a coupling) on a wall-surface side of the structural object are mounted. Then, it is possible to obtain information on an imaging position of the imaging unit based on, for example, information (signal) of the distance measurement unit, and to conduct unmanned inspection inside the structural object.

Patent Document 2 discloses a signal processing device of a scanning ranging apparatus capable of properly detecting a monitoring target present behind an object which is a noise source. Moreover, Non-Patent Document 1 discloses a multiecho sensor capable of measuring a plurality of reflected lights with laser beams in a single direction, respectively. Non-Patent Document 1 discloses that a conventional laser range sensor calculates a distance value from a first returned echo, whereas the multiecho sensor can obtain distance values for a plurality of returned echoes (reflected waves), respectively, and is thus characterized by a strong resistance against noise caused by a light transmissive substance, a boundary of objects, rain, dew, snow, or the like.

### CITATION LIST

### Patent Literature

Patent Document 1: JP2016-15628A
Patent Document 2: JP2012-242189A

### Non-Patent Literature

Non-Patent Document 1: Kota Sato, et al., “Research on character of laser range sensor capable of acquiring multiecho”, 2012, May 27

### SUMMARY

### Technical Problem

However, when a space incapable of using a means for capturing a position, such as GPS, from outside (will be referred to as a closed space, hereinafter), for example, the inside of a combustion furnace undergoes maintenance inspection after the start of an operation, soot and dust such as combustion ash caused by the previous operation are deposited inside the combustion furnace and the like. When maintenance inspection of such closed space is conducted by using an unmanned aerial vehicle having a propeller and the like, the deposited soot and dust are stirred up by airflow generated by the propeller and the like. Thus, it is newly found that in the laser range sensor presupposing absence of such soot and dust (reflection source), a distance between the unmanned aerial vehicle and an inner wall surface of a furnace wall cannot appropriately be measured due to an influence of reflected waves by countless soot and dust floating in the closed space. Moreover, although it may be considered that dispersal of the deposits is suppressed by sprinkling water or the like in advance so the deposited soot and dust are not dispersed by flight of the unmanned aerial vehicle, such up-front work is required.

In view of the above, an object of at least one embodiment of the present invention is to provide an unmanned aerial vehicle capable of accurately measuring a distance between itself and a stationary object, even if a reflection object such as soot and dust exists in the closed space.

### Solution to Problem

(1) An unmanned aerial vehicle according to at least one embodiment of the present invention is an unmanned aerial vehicle configured to fly in a closed space, which includes an airframe, a thrust generating means configured to generate a thrust for the airframe to fly in air, and a length measuring means mounted on the airframe. The length measuring means includes a transmission unit configured to transmit a measurement wave, a reception unit configured to receive reflected waves of the measurement wave, and a distance calculation unit configured to calculate a distance between the unmanned aerial vehicle and a stationary object present in the closed space based on the reflected waves of the measurement wave transmitted from the transmission unit which are received a plurality of times by the reception unit.

With the above configuration (1), the unmanned aerial vehicle such as a drone includes the length measuring means for measuring, based on the reflected waves of the measurement wave such as a pulse laser or a millimeter wave transmitted from the transmission unit, the distance between the unmanned aerial vehicle and the stationary object (inner wall surface) which is a wall surface or the like forming, for example, a combustion furnace such as a boiler or a stack. The length measuring means can measure the distance between the unmanned aerial vehicle and the stationary object based on the plurality of reflected waves received with respect to the transmitted measurement wave (pulse). Thus, measuring the distance between the unmanned aerial vehicle and the stationary object based on the plurality of reflected waves, it is possible to accurately measure the distance between the unmanned aerial vehicle and the stationary object, and to implement inspection in the closed space by the unmanned aerial vehicle, even if soot and dust such as combustion ash exist between the length measuring means (reception unit) and the stationary object.

That is, in conducting maintenance inspection of the interior space (closed space) of, for example, the combustion furnace after an operation thereof, the soot and dust such as the combustion ash deposited in the closed space are stirred up by flight of the unmanned aerial vehicle, and thus the countless floating soot and dust exist between the length measuring means and the stationary object. Thus, the measurement wave transmitted from the transmission unit reflects not only from the stationary object but also from the soot and dust floating between the length measuring means and the stationary object, resulting in the reception unit receiving (detecting) a plurality of reflections obtained at various positions, respectively. Nevertheless, if distance measurement is performed presupposing that the soot and dust do not exist between the length measuring means and the stationary object, and the reflected waves are received only from the stationary object, it is impossible to correctly measure the distance between the unmanned aerial vehicle and the stationary object. However, since the length measuring means measures the distance between the unmanned aerial vehicle and the stationary object based on the plurality of reflected waves as described above, it is possible to accurately measure the distance between the unmanned aerial vehicle and the stationary object.

Moreover, if a position of the unmanned aerial vehicle in the closed space is obtained based on the distance measured by the length measuring means, it is possible to accurately calculate the above-described position, making it possible to accurately obtain an inspection position and to autonomously fly the unmanned aerial vehicle along a predetermined flight route or the like. Therefore, it is also possible to efficiently conduct the inspection in the closed space by the unmanned aerial vehicle.

(2) In some embodiments, in the above configuration (1), the length measuring means measures at least a distance to the stationary object in a horizontal direction.

With the above configuration (2), the length measuring means measures at least the distance between the unmanned aerial vehicle and the stationary object present in the horizontal direction. Thus, it is possible to provide the unmanned aerial vehicle capable of conducting unmanned inspection of the closed space. A distance (height) in the vertical direction may be measured by using another means such as a barometer.

(3) In some embodiments, in the above configuration (1) or (2), the thrust generating means includes a propeller, the transmission unit includes a horizontal transmission unit configured to transmit the measurement wave in a horizontal direction, the reception unit includes a horizontal reception unit configured to receive the reflected waves of the measurement wave transmitted from the horizontal transmission unit, and the horizontal transmission unit and the horizontal reception unit are installed above the propeller.

With the above configuration (3), the unmanned aerial vehicle is, for example, the drone including the propeller as the thrust generating means. Moreover, the length measuring means includes the transmission unit (horizontal transmission unit) and the reception unit (horizontal reception unit) for measuring the distance between the unmanned aerial vehicle and the stationary object in the horizontal direction, and the horizontal transmission unit and the horizontal reception unit are installed on the airframe to be disposed above the propeller in the airframe of the unmanned aerial vehicle. The present inventors have found that the soot and dust floated by a rotation of the propeller mainly float below the propeller. Thus, disposing the length measuring means for measuring the distance between the unmanned aerial vehicle and the stationary object in the horizontal direction above the propeller, it is possible to measure the distance between the unmanned aerial vehicle and the stationary object positioned in the horizontal direction in an environment with the lesser soot and dust floating between the length measuring means and the stationary object. Thus, it is possible to improve measurement accuracy of the above-described distance in the horizontal direction.

(4) In some embodiments, in any one of the above configurations (1) to (3), the transmission unit includes a vertical transmission unit configured to transmit the measurement wave downward in a vertical direction, and the reception unit includes a vertical reception unit configured to receive the reflected waves of the measurement wave transmitted from the vertical transmission unit.

With the above configuration (4), the length measuring means includes the transmission unit (vertical transmission unit) and the reception unit (vertical reception unit) for measuring the distance (height) between the unmanned aerial vehicle and the stationary object in the vertical direction. Thus, it is possible to measure the above-described distance in the vertical direction.

(5) In some embodiments, in the above configuration (4), the thrust generating means includes a propeller, and the vertical transmission unit and the vertical reception unit are installed below the propeller.

With the above configuration (5), the unmanned aerial vehicle is, for example, the drone including the propeller as the thrust generating means. Moreover, the length measuring means includes the transmission unit (vertical transmission unit) and the reception unit (vertical reception unit) for measuring the distance (height) between the unmanned aerial vehicle and the stationary object in the vertical direction, and the vertical transmission unit and the vertical reception unit are installed on the airframe to be disposed below the propeller. Thus, it is possible to measure the distance between the unmanned aerial vehicle and the stationary object positioned in the vertical direction without any influence of the reflected waves from the propeller. Thus, it is possible to improve measurement accuracy of the above-described distance in the vertical direction.

(6) In some embodiments, in any one of the above configurations (1) to (5), the unmanned aerial vehicle further includes a position calculation unit configured to calculate a position of the unmanned aerial vehicle based on the distance.

With the above configuration (6), the unmanned aerial vehicle calculates an in-flight position based on the distance between itself and the stationary object. Thus obtaining the position of the in-flight unmanned aerial vehicle based on the above-described distance L, it is possible to accurately obtain a position in shooting by the imaging means. Thus, when actual maintenance work becomes necessary through inspection based on the image, it is possible to quickly specify and access a position in the closed space to undergo the maintenance work corresponding to the shooting position of the image. Moreover, it is possible to autonomously fly the unmanned aerial vehicle along a flight route determined in advance by, for example, programming. Thus, it is possible to perform the inspection work (such as the flight along the flight route and image shooting) without a human operating the unmanned aerial vehicle from a remote place, and to make the inspection work easy and efficient.

(7) In some embodiments, in any one of the above configurations (1) to (6), the unmanned aerial vehicle further includes an imaging means mounted on the airframe.

With the above configuration (7), the unmanned aerial vehicle includes the imaging means such as a camera. Thus, it is possible to obtain a shot image of an inspection target. Moreover, obtaining positional information together with the shot image, in case a failure such as damage to the inspection target is confirmed from the image, it is possible to easily specify a position where the failure is caused and to facilitate maintenance work based on inspection.

(8) In some embodiments, in any one of the above configurations (1) to (7), the stationary object is a wall forming the closed space which is an interior space of a combustion furnace.

With the above configuration (8), it is possible to easily conduct furnace maintenance inspection of the combustion furnace, where the combustion ash and the like are deposited due to the operation of the combustion furnace, by the unmanned aerial vehicle. It is possible to eliminate a need to build a scaffolding or the like, making it also possible to implement a reduction in effort, cost, and inspection period for the need.

(9) An inspection method according to at least one embodiment of the present invention is an inspection method in a closed space by using an unmanned aerial vehicle, which includes a flight step of flying the unmanned aerial vehicle in the closed space, and a length measurement step of measuring a distance between the unmanned aerial vehicle and a stationary object present in the closed space, during the flight of the unmanned aerial vehicle. The length measurement step includes a transmission step of transmitting a measurement wave, a reception step of receiving reflected waves of the measurement wave, and a distance calculation step of calculating the distance between the unmanned aerial vehicle and the stationary object based on the reflected waves of the measurement wave transmitted in the transmission step which are received a plurality of times in the reception step.

With the above configuration (9), it is possible to achieve the same effect as the above configuration (1).

(10) In some embodiments, in the above configuration (9), the inspection method further includes a position calculation step of calculating a position of the unmanned aerial vehicle based on the distance.

With the above configuration (10), it is possible to achieve the same effect as the above configuration (6).

(11) In some embodiments, in the above configuration (9) or (10), the inspection method further includes a shooting step of shooting at least one portion of an inspection target present in the closed space.

With the above configuration (11), it is possible to achieve the same effect as the above configuration (7).

### Advantageous Effects

According to at least one embodiment of the present invention, an unmanned aerial vehicle capable of accurately measuring a distance between itself and a stationary object, even if a reflection object such as soot and dust exists in a closed space, is provided.

### BRIEF DESCRIPTION OF DRAWINGS

FIG. 1 is a schematic view of an unmanned aerial vehicle according to an embodiment of the present invention.

FIG. 2 is a schematic diagram showing the configuration of a length measuring means according to an embodiment of the present invention.

FIG. 3 is a flowchart of an inspection method according to an embodiment of the present invention.

### DETAILED DESCRIPTION

Some embodiments of the present invention will be described below with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same”, “equal”, and “uniform” shall not be construed as indicating only the state in which the feature is strictly equal, but also includes a state in which there is a tolerance or a difference that can still achieve the same function.

Further, for instance, an expression of a shape such as a rectangular shape or a tubular shape shall not be construed as only the geometrically strict shape, but also includes a shape with unevenness or chamfered corners within the range in which the same effect can be achieved.

On the other hand, the expressions “comprising”, “including”, “having”, “containing”, and “constituting” one constituent component are not exclusive expressions that exclude the presence of other constituent components.

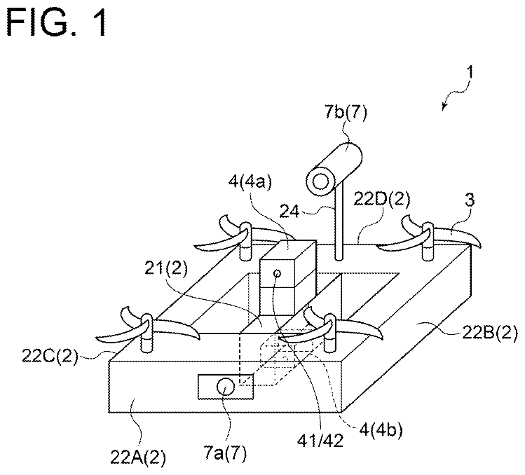

FIG. 1 is a schematic view of an unmanned aerial vehicle 1 according to an embodiment of the present invention. The unmanned aerial vehicle 1 is an Unmanned Aerial Vehicle (UAV) configured to fly in a closed space S, such as a drone including a propeller. The above-described closed space S is a space formed inside a structural object. More specifically, for example, the closed space is an interior space of a stack or a combustion furnace such as a boiler or a garbage incinerator, and is a space where soot and dust d such as combustion ash are deposited. The closed space S may include a communication part for a part of the closed space S to communicate with others. For example, an interior space of a boiler (furnace) having a rectangular cross-sectional shape in the horizontal direction is a space including a combustion space for fuel combustion, the space is formed by a side wall part disposed such that the above-described cross-section has a rectangular shape, a ceiling part connected to the upper portion of the side wall part, and a bottom part connected to the lower portion of the side wall part, and a communication part for communicating with a duct of the boiler is formed in, for example, the upper portion of the side wall part. Moreover, the interior space of the stack includes a side wall part for forming a flow passage where an exhaust gas passes. The upper portion of the side wall part communicates with the outside (atmosphere), and the lower portion of the side wall part communicates with the inside of a pipe connected to an exhaust gas treatment device or the like.

Then, as shown in FIG. 1, the above-described unmanned aerial vehicle 1 includes an airframe 2, a thrust generating means 3 configured to generate a thrust for the airframe 2 to fly in the air, and a length measuring means 4 mounted (installed) on the airframe 2. The unmanned aerial vehicle 1 may further include an inspection information acquisition means such as an imaging means 7. The unmanned aerial vehicle 1 may also include a position calculation unit 5.

Describing in detail, the airframe 2 is a portion of the unmanned aerial vehicle 1 except for the thrust generating means 3 and the parts such as the length measuring means 4 mounted on the airframe 2. In the embodiment shown in FIG. 1, the airframe 2 includes an airframe body 21 and an airframe guard part 22 (front guard part 22A, left guard part 22B, right guard part 22C, rear guard part 22D) disposed to protect the periphery of the airframe body 21. Moreover, the thrust generating means 3 is a propeller (rotating blade), and the thrust generating means 3 are disposed at four corners on the upper surface of the airframe guard part 22 (four in total). The number of propellers is not limited to the present embodiment, but any number of propellers may be disposed.

Moreover, the airframe 2 is mounted with the inspection information acquisition means (object) needed to inspect the inside of the closed space S, for example, an inner wall surface of the structural object (stationary object 9) such as a wall forming the closed space S. More specifically, as shown in FIG. 1, on the airframe 2, the imaging means 7, which is capable of shooting images G such as still images and respective frames constituting a moving image, may be installed. In the embodiment shown in FIG. 1, the imaging means 7 includes a first camera 7a installed on a portion of the above-described front guard part 22A, and a second camera 7b installed on the rear guard part 22D via a support part 24. Moreover, the first camera 7a shoots the still images, and the second camera 7b shoots the moving image.

Then, with the imaging means 7, obtaining the shot images G of a pipe, a coupling, and the like disposed on the inner-surface side of the stationary object 9, it is possible to conduct inspection such as appearance inspection of the presence or absence of damage to the stationary object 9 based on the images G. The images G shot for such inspection may be stored in a storage medium m mounted on the imaging means 7 or the airframe 2. The storage medium m may be, for example, a flash memory detachably attached to the imaging means 7 or the like. At this time, the storage medium m may store a flight position P (to be described later) together with the images G. Alternatively, the images G may be transmitted to a computer (not shown) installed outside the structural object to be displayed on a screen of a display (not shown) or stored in a storage device (not shown). Both of them may be performed.

However, the present invention is not limited to the present embodiment. In some other embodiments, the airframe 2 may not include the airframe guard part 22 for protecting the airframe body 21. For example, centering around the airframe body 21 having any shape, such as the vertical direction becomes the longitudinal direction, the thrust generating means 3 such as the propellers may be disposed on the tip sides of rod-like members disposed to extend in a plurality of directions (for example, four directions), respectively, from the airframe body 21. At this time, the airframe body 21 may include a leg portion for the unmanned aerial vehicle 1 to stand on its own. Moreover, the thrust generating means 3 may be other known thrust generation device, such as a device for performing jet propulsion. The imaging means 7 may include at least one camera, and it is only necessary that each camera can shoot at least one of a still image or a moving image.

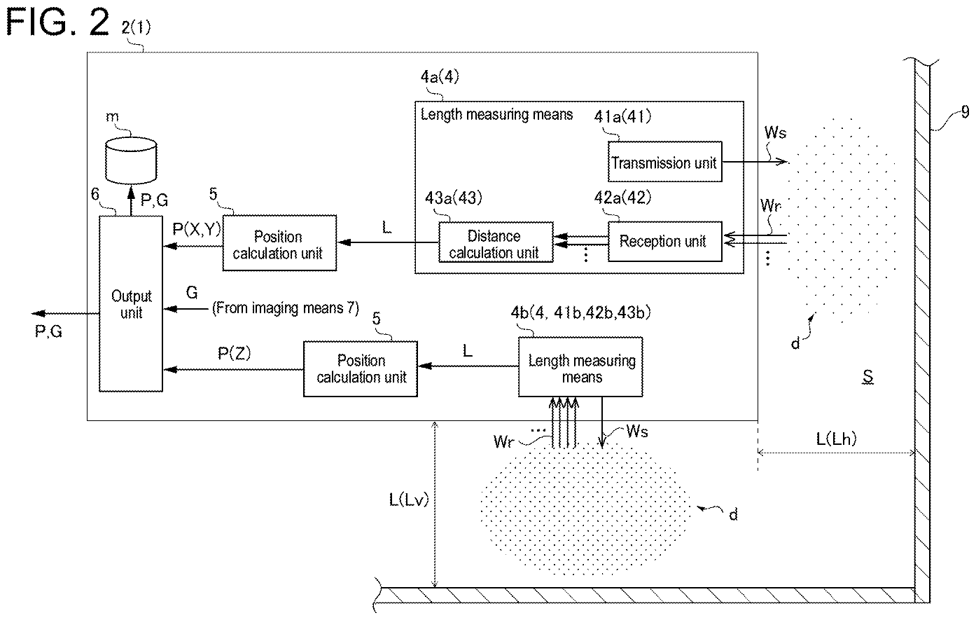

The length measuring means 4 of the unmanned aerial vehicle 1 having the above-described configuration includes, as shown in FIG. 2, a transmission unit 41 configured to transmit a measurement wave Ws, which is an electromagnetic wave or the like having directionality such as a laser or a millimeter wave, a reception unit 42 configured to receive (detect) reflected waves Wr of the measurement wave Ws, and a distance calculation unit 43 configured to calculate a distance L between the unmanned aerial vehicle 1 and the stationary object 9 present in the closed space S based on the reflected waves Wr of the measurement wave Ws transmitted from the transmission unit 41 which are received a plurality of times by the reception unit 42. In other words, the above-described distance L is a relative distance between the unmanned aerial vehicle 1 and the stationary object 9. That is, the length measuring means 4 is the signal processing device of the scanning ranging apparatus capable of properly detecting the monitoring target present behind the object which is the noise source (see Patent Document 2) or the multiecho sensor for calculating the distance L based on a plurality of echoes, not calculating the distance L from a first returned echo (reflected wave Wr) (see Non-Patent Document 1).

With such length measuring means 4, it is possible to accurately measure the distance L between the unmanned aerial vehicle 1 and the stationary object 9, even if the soot and dust d such as the combustion ash float in the closed space S, and the countless soot and dust d exist between the length measuring means 4 and the stationary object 9. That is, the present inventors have found that if the unmanned aerial vehicle 1 flies in the closed space S where the soot and dust d such as the combustion ash are deposited, the airflow generated by the thrust generating means 3 such as the propeller brings about the state in which the countless soot and dust d float in the closed space S. In addition, the present inventors have also found that in such a state, even if the distance L between the unmanned aerial vehicle 1 and the stationary object 9 is measured by using the laser range sensor for calculating the distance value from the first returned reflected wave Wr, the laser range sensor ends up calculating the distance value by the reflected waves Wr of the measurement wave Ws reflected from the countless soot and dust d present between the length measuring means 4 and the stationary object 9, making it impossible to measure the distance L to the stationary object 9. However, using the above-described length measuring means 4, the present inventors have confirmed that the distance L between the unmanned aerial vehicle 1 and the stationary object 9 can be measured accurately to a level without any practical problem.

With the above configuration, the unmanned aerial vehicle 1 such as the drone includes the length measuring means 4 for measuring, based on the reflected waves Wr of the measurement wave Ws such as a pulse laser or a millimeter wave transmitted from the transmission unit 41, the distance L between the unmanned aerial vehicle 1 and the stationary object 9 (inner wall surface) which is the wall surface or the like forming, for example, the combustion furnace such as the boiler or the stack, The length measuring means 4 can measure the distance L between the unmanned aerial vehicle 1 and the stationary object 9 based on the plurality of reflected waves Wr received with respect to the transmitted measurement wave Ws (pulse). Thus, measuring the distance L between the unmanned aerial vehicle 1 and the stationary object 9 based on the plurality of reflected waves Wr, it is possible to accurately measure the distance L between the unmanned aerial vehicle 1 and the stationary object 9 and to implement inspection in the closed space by the unmanned aerial vehicle, even if the soot and dust d such as the combustion ash exist between the length measuring means 4 (reception unit 42) and the stationary object 9.

Moreover, as will be described later, if a position of the unmanned aerial vehicle 1 in the closed space S is obtained based on the distance L measured by the length measuring means 4, it is possible to accurately calculate the above-described position, making it possible to accurately obtain the inspection position and to autonomously fly the unmanned aerial vehicle 1 along a predetermined flight route. Therefore, it is also possible to efficiently conduct the inspection in the closed space S by the unmanned aerial vehicle 1.

In some embodiments, the above-described length measuring means 4 only needs to measure the distance L to the stationary object 9 at least in the horizontal direction (for example, an X direction and a Y direction which are set along the horizontal plane and are orthogonal to each other) based on the reflected waves Wr received the plurality of times as described above.

That is, in some embodiments, as shown in FIGS. 1 and 2, the length measuring means 4 may be configured to measure the distances L (Lh, Lv) to the stationary object 9 positioned in the horizontal direction and the vertical direction (a Z direction which is a direction orthogonal to the X direction and the Y direction), respectively.

In the embodiments shown in FIGS. 1 and 2, as shown in FIGS. 1 and 2, the length measuring means 4 includes a horizontal length measuring means 4a for measuring the distance Lh between the unmanned aerial vehicle 1 and the stationary object 9 positioned in the horizontal direction, and a vertical length measuring means 4b for measuring the distance Lv between the unmanned aerial vehicle 1 and the stationary object 9 positioned in the vertical direction.

The horizontal length measuring means 4a at least includes a horizontal transmission unit 41a configured to transmit the measurement wave Ws in the horizontal direction, and a horizontal reception unit 42a configured to receive the reflected waves Wr of the measurement wave Ws transmitted from the horizontal transmission unit 41a.

On the other hand, the vertical length measuring means 4b includes a vertical transmission unit 41b configured to transmit the measurement wave Ws downward in the vertical direction, and a vertical reception unit 42b configured to receive the reflected waves Wr of the measurement wave Ws transmitted from the vertical transmission unit 41b.

The horizontal transmission unit 41a and the horizontal reception unit 42a may be configured to, for example, rotate together for the horizontal length measuring means 4a to measure the lengths of the two directions (X direction, Y direction), respectively, in the horizontal direction. Alternatively, the horizontal length measuring means 4a may include the horizontal transmission unit 41a and the horizontal reception unit 42a for performing measurement in the two directions, respectively, in the horizontal direction. Although different in length measurement direction, the horizontal length measuring means 4a and the vertical length measuring means 4b have the same configuration, and thus the details of the vertical length measuring means 4b are omitted in FIG. 2.

As shown in FIG. 2, the above-described horizontal length measuring means 4a may further include a horizontal distance calculation unit 43a configured to calculate the distance Lh between the unmanned aerial vehicle 1 and the stationary object 9 present in the closed space S based on the reflected waves Wr of the measurement wave Ws transmitted from the horizontal transmission unit 41a which are received the plurality of times by the horizontal reception unit 42a. Moreover, the vertical length measuring means 4b may further include a vertical distance calculation unit 43b configured to calculate the distance Lv between the unmanned aerial vehicle 1 and the stationary object 9 present in the closed space S based on the reflected waves Wr of the measurement wave Ws transmitted from the vertical transmission unit 41b which are received the plurality of times by the vertical reception unit 42b. Alternatively, the distance calculation unit 43 of the length measuring means 4 may be connected to the horizontal distance calculation unit 43a and the vertical distance calculation unit 43b, and configured to calculate the both distances L (Lh, Lv) in the horizontal direction and the vertical direction.

Moreover, in the embodiment shown in FIG. 1, the horizontal length measuring means 4a is installed above the propeller (thrust generating means 3). In addition, the vertical length measuring means 4b is installed below the propeller.

The present inventors have found that the soot and dust d floated by the rotation of the propeller mainly float below the propeller. Thus, disposing the length measuring means 4 for measuring the distance (Lh) between the unmanned aerial vehicle 1 and the stationary object 9 in the horizontal direction above the propeller, it is possible to measure the distance L between the unmanned aerial vehicle 1 and stationary object 9 positioned in the horizontal direction in an environment with the lesser soot and dust d floating between the length measuring means 4 and the stationary object 9. Thus, it is possible to improve measurement accuracy of the above-described distance L (Lh) in the horizontal direction.

Moreover, installing the vertical transmission unit 41b and the vertical reception unit 42b on the airframe 2 to be disposed below the propeller, it is possible to measure the distance L (Lv) between the unmanned aerial vehicle 1 and the stationary object 9 positioned in the vertical direction without any influence of the reflected waves Wr from the propeller. Thus, it is possible to improve measurement accuracy of the above-described distance L (Lv) in the vertical direction.

In some other embodiments, it may be configured such that the length measuring means 4 measures only the distance Lh between the unmanned aerial vehicle 1 and the stationary object 9 positioned in the horizontal direction, and another means such as a barometer measures the distance Lv between the unmanned aerial vehicle 1 and the stationary object 9 positioned in the vertical direction.

With the above configuration, the length measuring means 4 measures at least the distance L between the unmanned aerial vehicle 1 and the stationary object 9 present in the horizontal direction. Thus, it is possible to provide the unmanned aerial vehicle 1 capable of conducting unmanned inspection of the closed space S.

Moreover, in some embodiments, as shown in FIG. 2, the unmanned aerial vehicle 1 may further include a position calculation unit 5 configured to calculate a position in measurement of the distance L of the unmanned aerial vehicle 1 (will be referred to as the flight position P, hereinafter) based on the distance L to the stationary object 9 measured by the length measuring means 4. Thus, the unmanned aerial vehicle 1 can obtain the in-flight flight position P. The present inventors have confirmed that the thus calculated flight position P is obtained accurately to a level without any inspection problem or any problem of implementing autonomous flight (to be described later).

In the embodiment shown in FIG. 2, the unmanned aerial vehicle 1 further includes an output unit 6 for outputting, to the above-described computer (not shown), the storage medium m, or the like installed outside the structural object, the image G shot by the imaging means 7 and the flight position P in shooting by the imaging means 7, which is calculated by the position calculation unit 5, to be associated with each other. The output unit 6 is connected to the above-described position calculation unit 5, thereby obtaining a three-dimensional position in the closed space S specified by respective positions in the X direction, the Y direction, and the Z direction. It is only necessary that the output unit 6 outputs the image G and the flight position P to at least one of the storage medium m or the above-described computer (not shown).

With the above configuration, the unmanned aerial vehicle 1 calculates the in-flight position based on the distance L between itself and the stationary object 9. Thus obtaining the position of the in-flight unmanned aerial vehicle 1 based on the above-described distance L, it is possible to accurately obtain the position in shooting by the imaging means 7. Thus, when actual maintenance work becomes necessary through the inspection based on the image G, it is possible to quickly specify and access a position in the closed space S to undergo the maintenance work corresponding to the shooting position of the image G. Moreover, it is possible to autonomously fly the unmanned aerial vehicle 1 along the flight route determined in advance by, for example, programming. Thus, it is possible to perform the inspection work (such as the flight along the flight route and image shooting) without a human operating the unmanned aerial vehicle 1 from a remote place, and to make the inspection work easy and efficient. The unmanned aerial vehicle 1 may remotely be operated by a human manually while watching the image G (such as the moving image) displayed on a screen from outside the structural object.

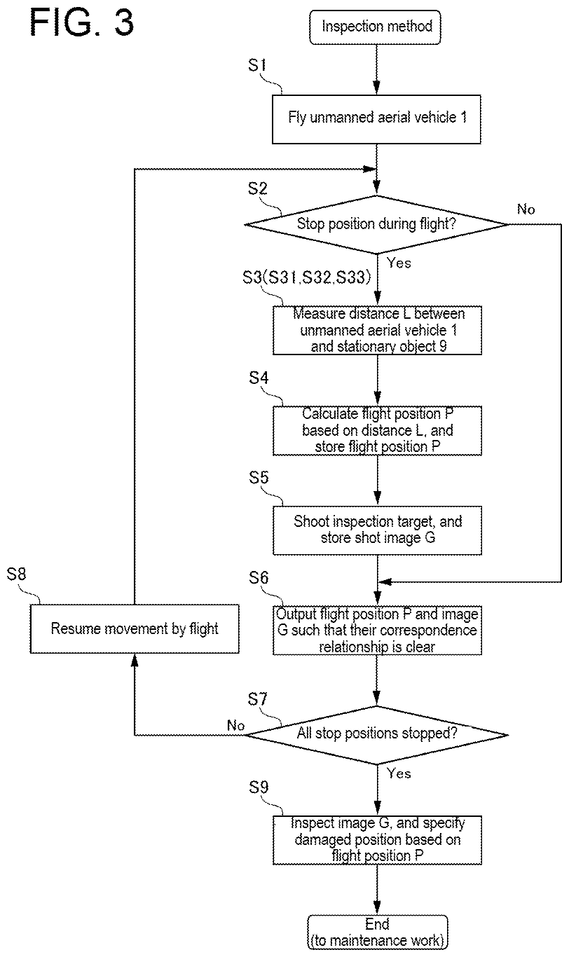

Hereinafter, an inspection method using the above-described unmanned aerial vehicle 1 will be described with reference to FIG. 3. FIG. 3 is a flowchart of the inspection method according to an embodiment of the present invention.

The inspection method is an inspection method in the closed space S using the unmanned aerial vehicle 1. As shown in FIG. 3, the inspection method includes a flight step (S1) of flying the unmanned aerial vehicle 1 in the closed space S, and a length measurement step (S3) of measuring the distance L between the unmanned aerial vehicle 1 and the above-described stationary object 9 present in the closed space S during the flight of the unmanned aerial vehicle 1. In addition, the above-described length measurement step (S3) includes a transmission step (S31) of transmitting the above-described measurement wave Ws, a reception step (S32) of receiving the reflected waves Wr of the measurement wave Ws, and a distance calculation step (S33) of calculating the distance L between the unmanned aerial vehicle 1 and the stationary object 9 based on the reflected waves Wr of the measurement wave Ws transmitted in the above-described transmission step (S32) which are received a plurality of times in the above-described reception step (S31).

The above-described length measurement step (S3) and the transmission step, the reception step, and the distance calculation step of the length measurement step (S3) are, respectively, the same as the processing contents performed by the length measuring means 4, the transmission unit 41, the reception unit 42, and the distance calculation unit 43 that have already been described, and thus the details of which are to be omitted. Moreover, the flight step (S1) is performed by flying the airframe 2 with the thrust generating means 3 that has already been described.

In the embodiment shown in FIG. 3, the flight step is performed in step S1. The unmanned aerial vehicle 1 may fly, for example, the predetermined flight route. Step S2 includes confirming whether the unmanned aerial vehicle 1 arrives at at least one stop position set on the flight route when the unmanned aerial vehicle 1 flies along the flight route. Then, if the unmanned aerial vehicle 1 arrives at the stop position, the length measurement step (S3) is performed while the unmanned aerial vehicle 1 is stopped in the air. That is, if the unmanned aerial vehicle 1 arrives at the stop position in step S2, step S3 includes performing the length measurement step (S3) while the unmanned aerial vehicle 1 is stopped in the air. More specifically, step S3 includes performing the transmission step (S31), the reception step (S32), and the distance calculation step (S33) described above. Thus measuring the distance L between the unmanned aerial vehicle 1 and the stationary object 9 based on the plurality of reflected waves Wr in the length measurement step (S3), it is possible to accurately measure, for example, the distance L in each of the vertical direction (Z direction) and the two directions (X direction, Y direction) in the horizontal direction even if the soot and dust d exist.

In some embodiments, as shown in FIG. 3, the inspection method may further include a position calculation step (S4) of calculating the position (flight position P) of the unmanned aerial vehicle 1 based on the above-described distance L. The position calculation step (S4) is the same as the processing contents performed by the position calculation unit 5 that have already been described, and thus details of which are to be omitted. In the embodiment shown in FIG. 3, step S4 includes performing the position calculation step. At this time, the flight position P calculated by performing the position calculation step (S4) is stored.

Moreover, in some embodiments, as shown in FIG. 3, the inspection method may further include a shooting step (S5) of shooting at least one portion of an inspection target present in the closed space S. The inspection target is, for example, the above-described stationary object 9 (inner wall surface). The shooting step (S5) is performed by using the imaging means 7 of the unmanned aerial vehicle 1 that has already been described. In the embodiment shown in FIG. 3, step S5 includes performing the shooting step. At this time, the image G shot by performing the shooting step (S5) is stored.

In addition, in the embodiment shown in FIG. 3, after performing step S5, the inspection method includes an output step (S6) of outputting the flight position P obtained by performing the position calculation step (S4) and the image G obtained by performing the shooting step (S5) to be associated with each other. In some embodiments, the output step (S6) may output the image G and the flight position P to the above-described storage medium m to store them in association with each other. In some other embodiments, the output step (S6) may output the image G and the flight position P to, for example, the computer outside the closed space S by communication such as wireless communication. In this case, the flight position P and the image G may simultaneously be output on the same screen. Both of these embodiments may be performed.

Subsequently, step S7 includes confirming whether the unmanned aerial vehicle 1 arrives at all stop positions set on the flight route. Then, if the unmanned aerial vehicle 1 has not yet stopped at all the stop positions, movement by flight is resumed in step S8, and the process returns to immediately before step S2 (between S1 and S2). On the other hand, if the unmanned aerial vehicle 1 has already stopped at all the stop positions, the unmanned aerial vehicle 1 stops flying (is landed), for example. Subsequently, step S9 includes checking (inspecting) the presence or absence of, for example, damage to the inspection target based on the image G. At this time, if there is the image G where the damage or the like is confirmed, since the flight position P is associated with the image G, it is possible to specify the actual position in the closed space S based on the flight position P where the image G is shot and to perform the maintenance work.

In the embodiment shown in FIG. 3, the shooting step (S5) is performed after the position calculation step (S4) is performed. However, the order may be reversed. Moreover, step S9 may be performed in parallel during flight (before Yes in step S7).

The present invention is not limited to the above-described embodiments, and also includes an embodiment obtained by modifying the above-described embodiments and an embodiment obtained by combining these embodiments as appropriate.

### REFERENCE SIGNS LIST

1 Unmanned aerial vehicle
2 Airframe
21 Airframe body
22 Airframe guard part
22A Front guard part
22B Left guard part
22C Right guard part
22D Rear guard part
24 Support part
3 Thrust generating means
4 Length measuring means
4a Horizontal length measuring means
4b Vertical length measuring means
41 Transmission unit
41a Horizontal transmission unit
41b Vertical transmission unit
41 Reception unit
42a Horizontal reception unit
42b Vertical reception unit
43 Distance calculation unit
43a Horizontal distance calculation unit
43b Vertical distance calculation unit
5 Position calculation unit
6 Output unit
7 Imaging means
7a First camera
7a Second camera
9 Stationary object
S Closed space
L Distance
Lh Distance in horizontal direction
Lv Distance in vertical direction
Ws Measurement wave
Wr Reflected wave
P Flight position
m Storage medium
d Soot and dust

1. An unmanned aerial vehicle configured to fly in a closed space, comprising:
an airframe;
a thrust generating means configured to generate a thrust for the airframe to fly in air; and
a length measuring means mounted on the airframe,
wherein the length measuring means includes:
a transmission unit configured to transmit a measurement wave;
a reception unit configured to receive reflected waves of the measurement wave; and
a distance calculation unit configured to calculate a distance between the unmanned aerial vehicle and a stationary object present in the closed space based on the reflected waves of the measurement wave transmitted from the transmission unit which are received a plurality of times by the reception unit.

2. The unmanned aerial vehicle according to claim 1,
wherein the length measuring means measures at least a distance to the stationary object in a horizontal direction.

3. The unmanned aerial vehicle according to claim 1,
wherein the thrust generating means includes a propeller,
wherein the transmission unit includes a horizontal transmission unit configured to transmit the measurement wave in a horizontal direction,
wherein the reception unit includes a horizontal reception unit configured to receive the reflected waves of the measurement wave transmitted from the horizontal transmission unit, and
wherein the horizontal transmission unit and the horizontal reception unit are installed above the propeller.

4. The unmanned aerial vehicle according to claim 1,
wherein the transmission unit includes a vertical transmission unit configured to transmit the measurement wave downward in a vertical direction, and
wherein the reception unit includes a vertical reception unit configured to receive the reflected waves of the measurement wave transmitted from the vertical transmission unit.

5. The unmanned aerial vehicle according to claim 4,
wherein the thrust generating means includes a propeller, and
wherein the vertical transmission unit and the vertical reception unit are installed below the propeller.

6. The unmanned aerial vehicle according to claim 1, further comprising an imaging means mounted on the airframe.

7. The unmanned aerial vehicle according to claim 1, further comprising a position calculation unit configured to calculate a position of the unmanned aerial vehicle based on the distance.

8. The unmanned aerial vehicle according to claim 1,
wherein the stationary object is a wall forming the closed space which is an interior space of a combustion furnace.

9. An inspection method using an unmanned aerial vehicle configured to fly in a closed space, the method comprising:
a flight step of flying the unmanned aerial vehicle in the closed space; and
a length measurement step of measuring a distance between the unmanned aerial vehicle and a stationary object present in the closed space, during the flight of the unmanned aerial vehicle,
wherein the length measurement step includes:
a transmission step of transmitting a measurement wave;
a reception step of receiving reflected waves of the measurement wave; and
a distance calculation step of calculating the distance between the unmanned aerial vehicle and the stationary object based on the reflected waves of the measurement wave transmitted in the transmission step which are received a plurality of times in the reception step.

10. The inspection method according to claim 9, further comprising a shooting step of shooting at least one portion of an inspection target present in the closed space.

11. The inspection method according to claim 9, further comprising a position calculation step of calculating a position of the unmanned aerial vehicle based on the distance between the unmanned aerial vehicle and the stationary object present in the closed space.
